(19) United States
(12) Patent Application Publication
(10) Pub. No.: US 2018/0127965 A1
(43) Pub. Date: May 10, 2018

(54) FLUSH PLATE

(71) Applicant: MAG Aerospace Industries, LLC, Carson, CA (US)

(72) Inventors: David Beach, Los Alamitos, CA (US); Arnaud Namer, Torrance, CA (US); Timothy Morse, Aliso Viejo, CA (US); John Yu, Diamond Bar, CA (US); Steven Schwartz, Long Beach, CA (US); Russell Tomas, Santa Ana, CA (US); Razmik Boodaghians, Glendale, CA (US)

(73) Assignee: MAG Aerospace Industries, LLC, Carson, CA (US)

(21) Appl. No.: 15/794,587

(22) Filed: Oct. 26, 2017

Related U.S. Application Data
(60) Provisional application No. 62/420,229, filed on Nov. 10, 2016.

(51) Int. Cl. E03F 1/00

(52) U.S. Cl. CPC E03F 1/006; B64D 11/02

(57) ABSTRACT

Embodiments relate generally to flush plates having noncircular openings. In a specific example, the flush plate has a shark-fin shaped opening with an extending fin along a tail portion.

### CROSS REFERENCE TO RELATED APPLICATIONS

This application claims the benefit of U.S. Provisional Application Ser. No. 62/420,229, filed Nov. 10, 2016, titled “Flush Plate,” the entire contents of which are hereby incorporated by reference.

### FIELD OF THE DISCLOSURE

Embodiments of the present disclosure relate generally to flush plates having noncircular openings. In a specific example, the flush plate has a shark-fin shaped opening with an extending fin along a tail portion.

### BACKGROUND

Aircraft and other passenger transport vehicles typically have on-board lavatories with vacuum toilet systems. These systems include a waste-receiving toilet bowl connected to a main waste tank via a sewer pipe or main waste line. A discharge or flush valve is typically mounted on the sewer pipe to selectively allow fluid communication between the toilet bowl and the main waste tank. To power the toilet system, the waste reservoir is maintained under a pressure that is substantially lower than the pressure in the waste-receiving toilet bowl, which is typically under the near-atmospheric pressure of the aircraft's passenger cabin. Thus, when the discharge/flush valve is opened, the pressure differential between the toilet bowl and the reservoir causes the waste in the toilet bowl to be drawn through the pipe into the waste reservoir.

The pressure differential creating the vacuum for the flushing action may either be created via one or more vacuum pumps, or, in the case of an aircraft in flight, via a pressure differential between the pressurized cabin and reduced pressure outside the aircraft. For example, aircraft typically have a vacuum disposal system that applies a vacuum to pull waste media and flush water/spent water from toilets and/or sinks into an on-board waste water storage tank. During flight, the vacuum suction may be generated by the pressure differential between the pressurized cabin and the reduced pressure outside of an aircraft at high flight altitudes. Alternatively, the vacuum suction may be generated by a vacuum generator at ground level, at low flight altitudes, or if the system is used on a land or water-based vehicle.

In vacuum waste systems, this pressure differential is what drives the collected mixed media (which can be human waste along with other waste items) from the toilet bowl into the accumulation point (which is typically the vehicle main waste tank). A flush valve provides an interface for such a vacuum system without venting the pressure differential completely. It also allows for the controlled addition of material into the ambient-pressure environment, while providing a leak-free obstruction that can be moved or rotated in a controlled manner so as to allow for the passage of a waste bolus from the ambient-pressure environment (e.g., the toilet bowl) to the low pressure environment (e.g., the waste tank). The flush valve is then returned to its closed position in order to prevent further movement of media and/or waste into the waste tank until the next flush is activated. Exemplary flush valves for use with a vacuum toilet are shown and described by co-owned U.S. Pat. Nos. 6,325,356 and 9,428,896.

Flush plates are housed within a flush valve housing. The valve housing is typically a cylindrical housing with an inner chamber sized to contain a disk-shaped flush plate with an opening therein. One side of the housing has an inlet that is generally aligned with an outlet that is located on the opposite side of the housing. The waste-receiving toilet bowl is connected to the inlet of the valve housing by one portion of a sewer pipe, and the main waste tank is connected to the outlet of the valve housing via another portion of the sewer pipe.

A drive mechanism selectively rotates the disk-shaped flush plate between an open position and a closed position. In the open position, the opening in the flush plate is aligned between the inlet and the outlet, which allows fluid communication for the flushing of the vacuum toilet. In the closed position, the opening in the flush plate is moved away from the inlet and outlet area, such that a wall of the flush plate blocks fluid communication between the inlet and the outlet, preventing fluid from flowing between the bowl and the reservoir.

While many discharge valves or flush plates are available that achieve these tasks, they have some drawbacks. One challenge is that due to the high degree of differential pressure being controlled by the flush valve, vacuum toilets create a loud noise level during the flush. This is in part due to the amount of vacuum that needs to be applied in order to cause the septic waste to travel from the toilet basin to the holding tank. The loud flushing sound is created when the flush valve opens. The differential pressure forcefully draws the waste down the drain and must be large enough to cause the waste to flow the entire distance from the toilet basin to the septic holding tank. Improvements are desired.

### BRIEF SUMMARY

Embodiments of the invention described herein thus provide systems and methods for improved flush plates that can lower flush sounds. In one example, there is provided a flush plate, comprising: a flush plate opening with a shark-fin shaped tapered portion. The shark-fin shaped tapered portion may be defined by a circular outer circumference that curves into an extending fin. In a specific example, the shark-fin shaped tapered portion can comprise an outwardly curved wall and an elongated curved wall that meet at a tapered end.

Further examples provide a flush plate, comprising: a flush plate opening with and comprising a series of rounded undulating curves. Even further examples provide a flush plate, comprising: a flush plate opening with a radiused edge.

Other examples provide a vacuum toilet system comprising: a housing comprising first and second halves, the first half comprising an inlet opening and the second half comprising an outlet opening, wherein when the first and second halves are aligned, the inlet opening and the outlet opening are similarly aligned to form an inlet/outlet opening; a flush plate comprising an opening with an extending fin defined by an outwardly curved wall, wherein movement of the flush plate causes the extending fin to enter the inlet/outlet opening such that the outwardly curved wall of the extending fin creates a half-moon shape across the inlet/outlet opening during at least one position of the movement.

In another example, there is provided a flush valve system, comprising: a housing comprising first and second halves, the first half comprising an inlet opening and the second half comprising an outlet opening, wherein when the first and second halves are aligned, the inlet opening and the outlet opening are similarly aligned to form an inlet/outlet opening; a flush plate comprising an opening; wherein either the inlet/outlet opening or the flush plate comprise an extending fin defined by an outwardly curved wall, wherein movement of the flush plate causes the extending fin of either the flush plate or the inlet/outlet opening to cooperate with the other of the flush plate or the inlet/outlet opening such that the outwardly curved wall of the extending fin defines a half-moon shape across the inlet/outlet opening during at least one position of the movement.

### BRIEF DESCRIPTION OF THE DRAWINGS

FIG. 1 shows an exploded side perspective view of a flush valve housing and a flush plate.

FIG. 2A shows a front perspective view of a flush valve housing. FIG. 2B shows a rear perspective view of a flush valve housing.

FIGS. 3A-3D show a flush series of the prior art using a flush plate with a circular opening.

FIGS. 4A-4D show a flush series using a flush plate according to one of the embodiments disclosed herein.

FIG. 5 shows a top plan view of one example of a flush plate.

FIG. 6 shows a schematic and labeled opening of a flush plate.

FIG. 7 shows an alternate example of a flush plate having a series of undulating curved portions.

FIG. 8 shows an alternate example of a flush plate having a radiused edge.

FIG. 9 shows an alternate example of a flush plate having a kidney shape.

FIG. 10 shows an exploded side perspective view of a flush valve housing and a flush plate, with an alternate shape being provided on the housing.

### DETAILED DESCRIPTION

Embodiments of this disclosure provide an improved flush plate for use with a flush valve. In one aspect, the flush valve system functions as a flush valve for a vacuum toilet, particularly a vacuum toilet on-board a passenger transport vehicle. Although the valve system is described for use with a toilet system, and specifically for use with a vacuum toilet for use on-board a passenger vehicle such as an aircraft, it should be understood that this valve system may be used with any other system that seeks to use a valve across a pressure differential situation and/or a valve that can transport fluid and/or mixed media.

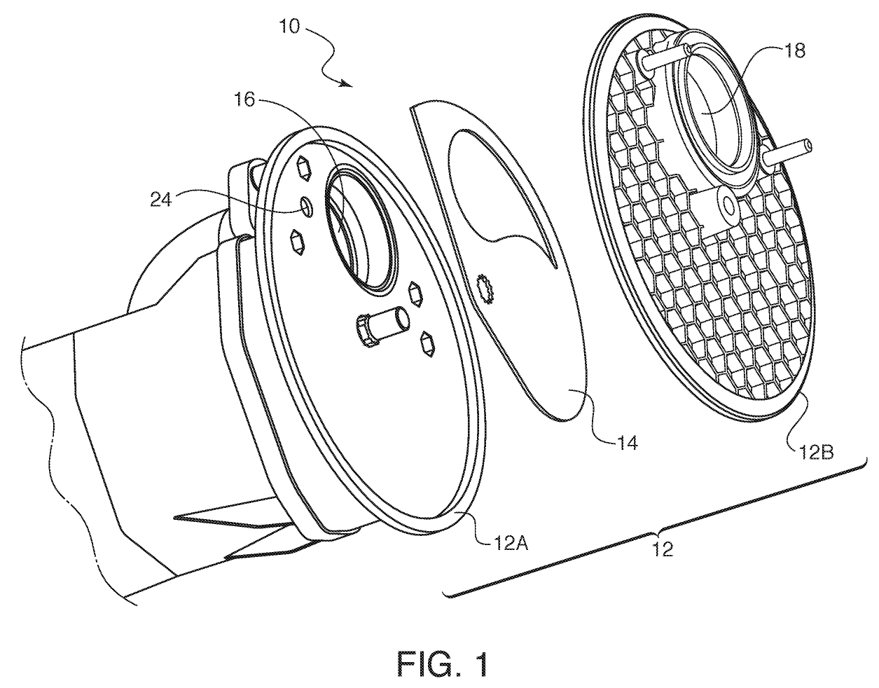

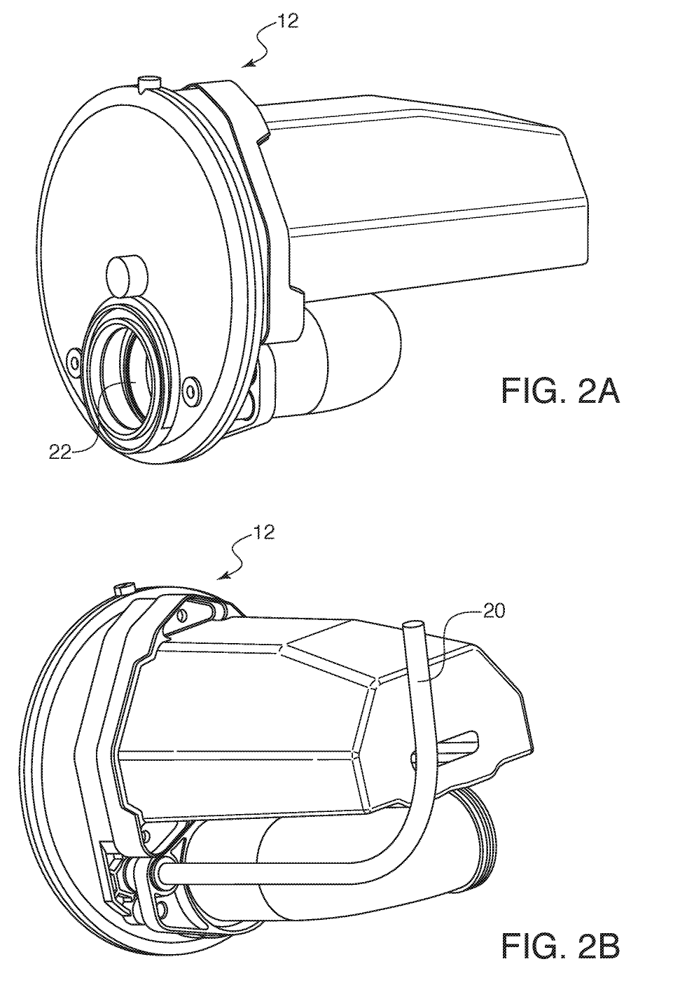

As shown in FIG. 1, the valve system 10 includes a valve housing 12 which encloses a flush plate 14. This internal flush plate 14 is used to control waste flow between a medial inlet opening 16 and an outlet 18 of the valve housing 12. In use, the media inlet opening 16 receives waste material from a toilet bowl (or in some embodiments, from an intermediate reservoir). The outlet 18 provides a connection to a sewer pipe, which delivers the waste to the main waste tank. The combined opening through the housing cross-section will be referred to collectively as “opening 22,” as illustrated by FIG. 2A.

The housing 12 has two halves (A and B). The waste inlet 16/outlet 18 opening collectively form opening 22 that extends through both halves A, B of the housing 12. A flush valve/flush plate 14 is provided between the two halves in order to control the opening and closing of the inlet 16/outlet 18 (collectively, the opening 22). The valve housing 12 may also be provided with one or more vent opening(s) 24, which functions to evacuate or vent air, providing a pathway between the valve system 10 interior and the ambient conditions immediately outside valve. The vent opening 24 may extend through one or both housing portions. In one example, the vent opening 24 only one housing portion. For example, it may be positioned on the inlet side of the housing. In other examples, the vent opening 24 may extend through both halves of the housing 12. Vent opening 24 may cooperate with the vent line 20, as illustrated by FIG. 2B. The valve system 10 described herein helps manage the desired flush sequence, while also maintaining the desired pressure in the system and allowing the system to vent. Venting may occur as shown and described by co-pending U.S. application Ser. No. 14/525,336 titled “Offset Seal Configuration for Vacuum Systems.”

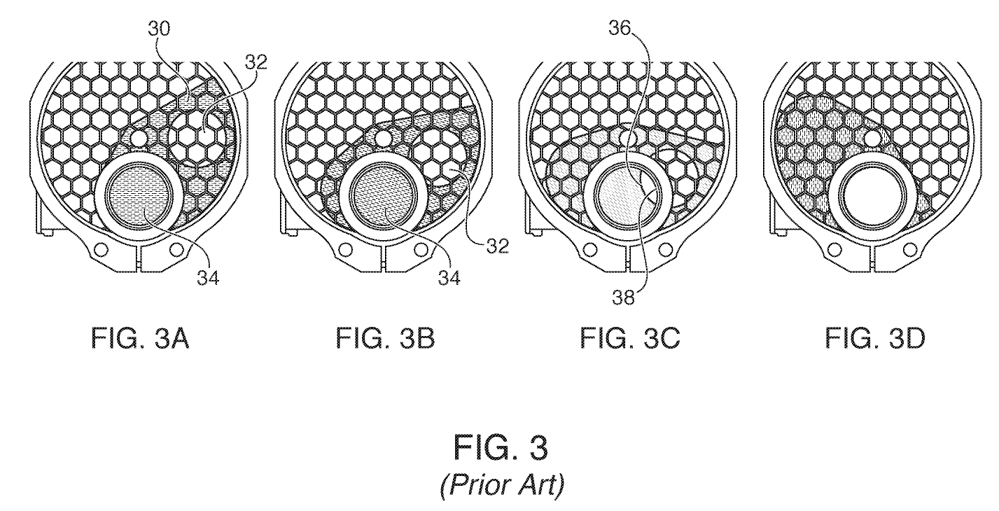

Referring now to previous flush valve systems, FIGS. 3A-3D show a flush valve opening sequence showing a typical flush plate shape 30. The flush plate 30 in this flush valve has a circular opening 32 of the prior art. During opening, the flush plate opening 32 moves in a downward arc. As shown by FIG. 3A, in the first position, the inlet/outlet opening 34 is not aligned with the flush plate opening 32. As the flush plate opening 32 begins to move toward alignment with the inlet/outlet opening 34, as shown by FIGS. 3B and 3C, a lower edge curvature portion 36 of the opening 32 begins to cross an upper edge curvature portion 38 of the opening 34. This opens the waste line from the top right corner downward until the opening 32 of the flush plate aligns with the opening 34 of the housing, as illustrated by FIG. 3D. With an average volume of waste present, the housing opening 34 is covered only partially. In other words, the liquid level may extend only about half way up the opening 34. When the valve opens to air (e.g., which, in this example, is the remaining upper half of the opening 34), the initial sound can be quite loud (e.g., 100+ dB).

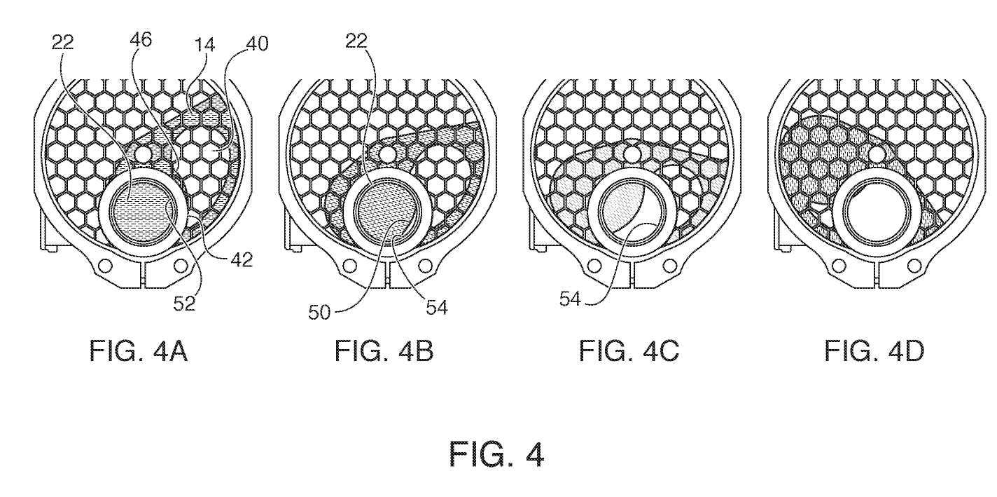

The present inventors have found that when the flush valve opens with a greater volume of liquid/waste present, the sound can be reduced. In some instances, the sound reduction can be up to almost 10 dB. In order to more effectively manage exposure of the opening to vacuum, Applicants have designed alternate flush plate opening shapes. One example is illustrated by FIGS. 4-6.

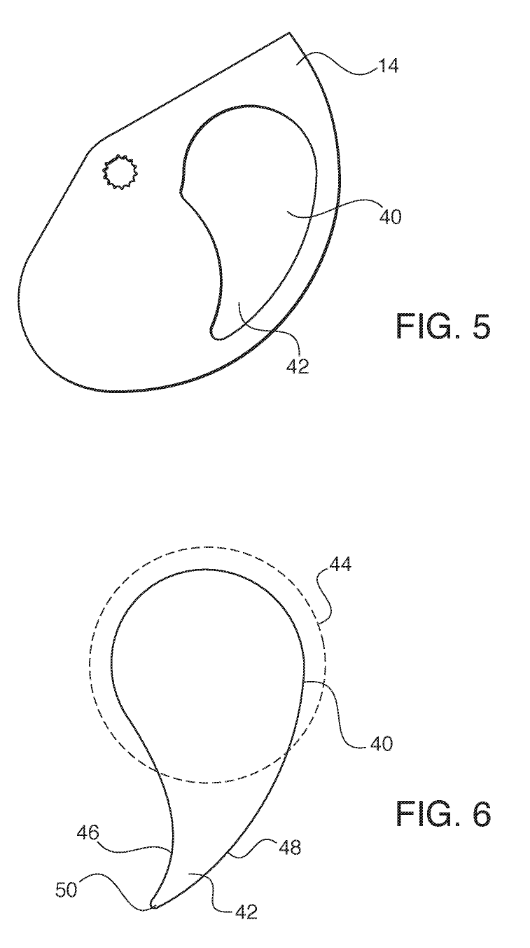

In this embodiment, the flush plate 14 has an opening 40 with an extending fin 42. The extending fin 42 may be shaped like a shark fin, illustrated by FIGS. 5 and 6. The opening 40 thus has one portion that resembles a circular outer circumference 44. However, rather than closing to form a complete circular perimeter, at about the semi-circle point (half way around), the opening has an outwardly curved wall portion 46 that curves away from continuing to form a circle. The opposite side of the opening defines an elongated curved wall 48. The outwardly curved wall portion 46 and the elongated curved wall 48 meet at a tapered end 50. The portion where the walls 46, 48 meet and define tapered end 50 resembles a shark fin. The resulting opening 40 resembles the appearance of one side of a yin/yang symbol.

As compared to prior flush valves, when opening with an average volume of waste, this flush plate opening 40 design allows the flush valve to open with more liquid volume present, rather than air volume. When the flush plate 14 is completely open, the circular outer circumference portion 44 is generally aligned with the housing opening 22.

As shown by FIG. 4A, in the closed position, the outwardly curved wall 46 tracks an upper/side edge curvature 52 of the housing opening 22. As the flush plate 14 begins its opening sequence, the tapered end 50 begins to enter the space defined by the opening 22 along a lower edge 54 of the opening 22. This is illustrated by FIGS. 4B and 4C. When the fin portion 42 of the flush plate 14 enters the opening 22, it is positioned lower on the inlet 16 of the valve. When the curved tapered end 50 reaches into the waste opening 22 of the housing, it creates a half-moon shape opening, illustrated by FIG. 4C. This allows the opening portion 22 to be more fully covered by liquid waste (based on average volume of a toilet evacuation/flush). The concept of covering the opening with liquid more fully before the flush process occurs can reduce initial noise of the flush. Preventing as much air (vacuum) from rushing through the opening can give the perception of a lower sound. It has been found that even small increments of sound reduction can make a large difference in the small confines of an aircraft lavatory.

A further benefit of providing an improved opening 40 shape is that the opening opens at a greater rate than with previous designs. This is illustrated by a comparison between FIG. 3C and FIG. 4C. The flush plate 40 with an extending fin 42 has traveled the same radial distance in FIG. 4C as the flush plate 30 of FIG. 3C. This comparison illustrates that the flush plate 14 of FIG. 4C provides up to or more than twice the flow area. This design can also help reduce sound even if the toilet bowl is empty during a flush by attaining full air flow quicker in the cycle, which reduces air velocity.

If, during closing, the valve becomes louder than current closing sound (e.g., because the rate of closing is greater than in other valves), it may be possible to speed the closing speed of the flush plate with a software change.

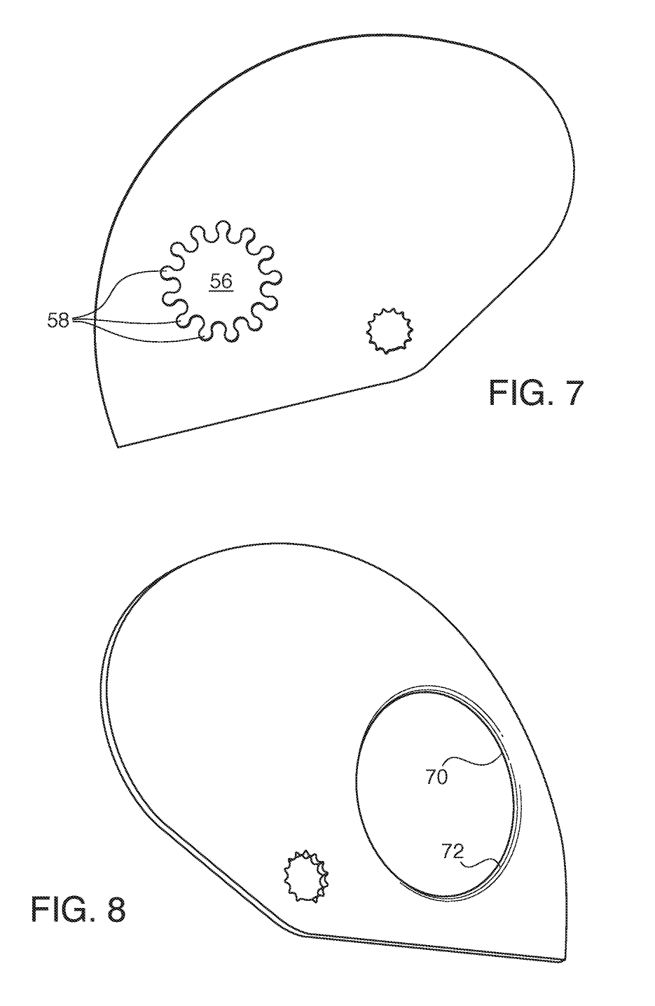

FIG. 7 shows an alternate opening shape. In this embodiment, the opening 56 is a shaped as a series of rounded undulating curves. For example, an individual undulating curve 58 may have a rounded upper portion that tapers into an inner base. The opening 58 resembles of undulating curves with valleys therebetween.

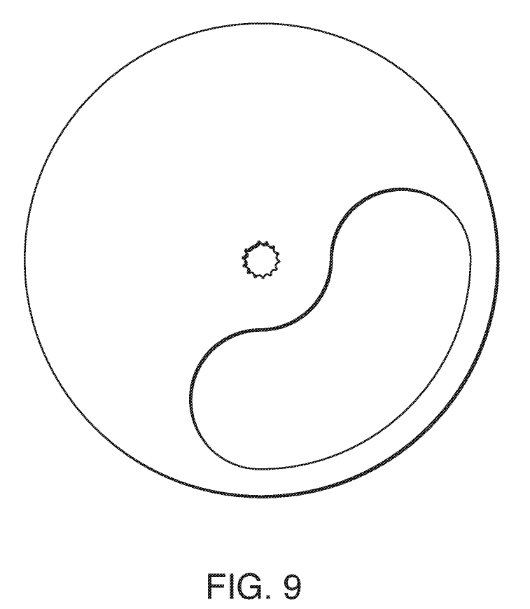

FIG. 8 illustrates another alternate opening shape. In this embodiment, the opening 70 has a radiused edge 72. For example, the inner circumference of the radiused edge is formed as an inward taper from the outer circumference.

FIG. 9 illustrates another alternate opening shape. In this embodiment, the opening has a kidney-like shape. For example, the shape may resemble an oval that has an inner indentation along one of the longer sides. These alternate embodiments may provide advantages similar to those described above.

Movement of the plate 14 may be controlled in any appropriate manner. In one embodiment, movement may be controlled by driving action of an actuator or motor, which is transferred by a gear assembly. A drive mechanism may selectively rotate the flush plate 14 between its various positions. The plate generally has a pivot point that cooperates along and around a shaft of the housing. The motor or actuator may be activated by any number of pre-set cues. For example, the movement of plate 14 may be governed by a vacuum or pressure sensor, which senses vacuum pressure and is set to move the flush plate 14 upon a set vacuum level. The movement of plate 14 may be governed by an electrical signal which is set to activate the flush plate 14 upon a set number of flushes or at set time intervals. The movement of plate 14 may be governed by a level sensor, which senses a liquid or waste level and is set to move the flush plate 14 upon a set level reading. The movement of plate 14 may be governed by a manual override, which allows a user to move the flush plate 14 as desired. The movement of plate 14 may be governed by any appropriate sensor, such as a pressure-based sensor, a capacitance-based sensor, or any other appropriate sensor sufficient to detect the presence or absence of waste.

In one specific system, a vacuum sensor, pressure sensor, electrical sensor, or any other sensor indicates a vacuum level or waste level to the system, indicating that a flush is needed. The system may alternatively be time-based or flush-based, indicating that a flush is needed after a certain amount of time or a certain number of flushes have occurred. The system may alternatively be manually activated, such that one in the lavatory can indicate that the holding tank should be cleared. In any event, a signal is sent to the system controller to indicate that a flush should occur. Once the flush has occurred, the controller can indicate that the plate 14 should move back to the waste opening 22 closed position, illustrated by FIG. 3A. This position does not allow any fluid or air flow at all.

The flush plate 14 may generally be sealed at the interface between the housing interior and the waste system. Any type and number of appropriate seals may be used in connection with the disclosure provided, as long as the seals allow the plate to rotate along its axis of rotation within the housing 12.

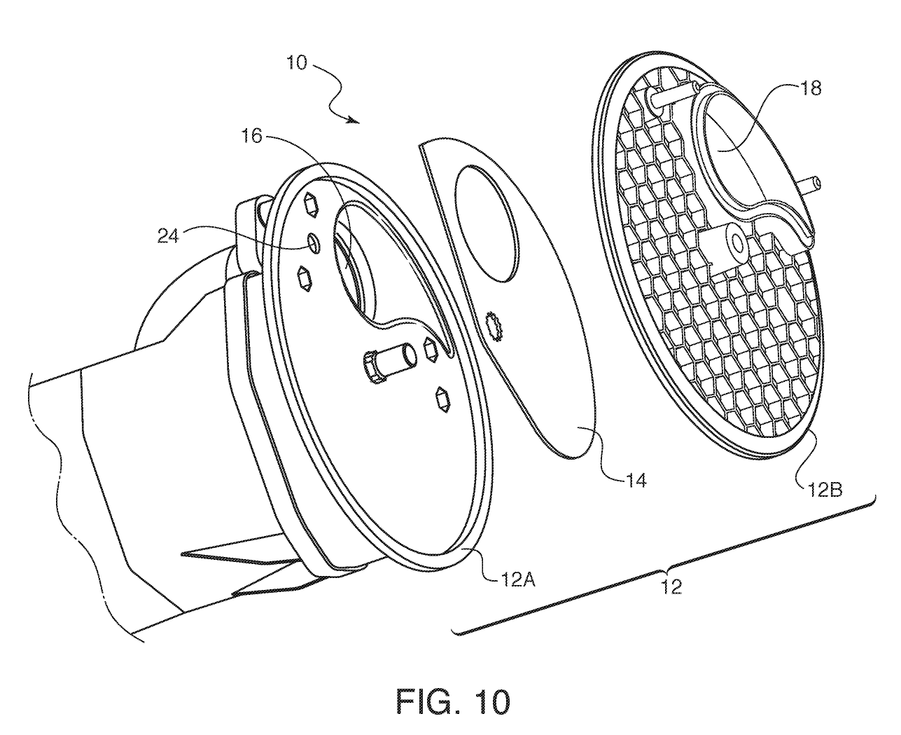

FIG. 10 illustrates an alternate configuration. In this configuration, the shark fin shape is present on the housing components, rather than on the flush plate. This embodiment can provide similar advantages to those described above in connection with the revised shape being positioned on the flush plate. Although the shark fin shape is the version illustrated in this reverse configuration, it should be understood that any of the other alternate shapes described herein may be positioned on the housing components while using a traditional circular-opening flush plate. Alternatively, the housing components may feature a first shape (including any of those described herein) and the flush plate may feature a second shape (including any of those described herein).

Materials:

The housing 12 may be made of any appropriate material. In some instances, the housing is metallic, such as stainless steel or titanium. In other instances, the housing may be plastic. It one embodiment, the housing may be made of a thermoplastic resin. In one embodiment, the housing made of a polymeric material that has good mechanical, thermal (to resist high temperatures), and chemical (resistance) properties. Specific examples of potential materials include but are not limited to polymers, polyetherimides (such as Ultem resin), nylons, such as nylon D80 or nylon 11, polypropylenes, acrylonitrile butadiene styrenes, polyethylenes, stereolithography resins (such as Somos® NeXt), carbon composite materials, carbon fibers in an epoxy matrix, polycarbonates, or any other appropriate materials, or any combination thereof. One or more coatings may be provided on the housing. Non-limiting examples of possible coatings include non-corrosion, non-stick, anti-microbial, and so forth. Without wishing to be bound to any theory, it is believed possible that providing the housing out of a plastic-like material may help the housing recover its original shape in the event of any abnormal or unintended shaving action of the flush plate.

The flush plate 14 may be made of any appropriate material. In some instances, the flush plate is metallic, such as stainless steel or titanium. These materials are corrosion resistant, and the plate is in contact with corrosive materials. In other instances, the flush plate may be plastic or any of the above-described materials for the housing. In some embodiments, the flush plate 14 may be coated. For example, a protective coating may be provided that helps give the plate features such as non-corrosion, non-stick, anti-microbial, and so forth. In a specific aspect, the plate may be coated with a Teflon coating. In a further specific aspect, the plate may be coated with a non-stick and/or a non-corrosive coating or material. The housing 12 and flush plate 14 may be made of the same or different materials.

Changes and modifications, additions and deletions may be made to the structures and methods recited above and shown in the drawings without departing from the scope or spirit of the disclosure or the following claims.

What is claimed is:

1. A flush plate, comprising:
a flush plate opening with a shark-fin shaped tapered portion.

2. The flush plate of claim 1, wherein the shark-fin shaped tapered portion is defined by a circular outer circumference that curves into an extending fin.

3. The flush plate of claim 1, where in the shark-fin shaped tapered portion comprises an outwardly curved wall and an elongated curved wall that meet at a tapered end.

4. A vacuum toilet system comprising:
a housing comprising first and second halves, the first half comprising an inlet opening and the second half comprising an outlet opening, wherein when the first and second halves are aligned, the inlet opening and the outlet opening are similarly aligned to form an inlet/outlet opening;
a flush plate comprising an opening with an extending fin defined by an outwardly curved wall,
wherein movement of the flush plate causes the extending fin to enter the inlet/outlet opening such that the outwardly curved wall of the extending fin creates a half-moon shape across the inlet/outlet opening during at least one position of the movement.

5. A flush plate, comprising:
a flush plate opening with and comprising a series of rounded undulating curves.

6. A flush plate, comprising:
a flush plate opening with a radiused edge.

7. A flush valve system, comprising:
a housing comprising first and second halves, the first half comprising an inlet opening and the second half comprising an outlet opening, wherein when the first and second halves are aligned, the inlet opening and the outlet opening are similarly aligned to form an inlet/outlet opening;
a flush plate comprising an opening;
wherein either the inlet/outlet opening or the flush plate comprise an extending fin defined by an outwardly curved wall,
wherein movement of the flush plate causes the extending fin of either the flush plate or the inlet/outlet opening to cooperate with the other of the flush plate or the inlet/outlet opening such that the outwardly curved wall of the extending fin defines a half-moon shape across the inlet/outlet opening during at least one position of the movement.
